(19) United States
(12) Patent Application Publication
(10) Pub. No.: US 2022/0004642 A1
(43) Pub. Date: Jan. 6, 2022

(54) VULNERABILITY ANALYSIS USING CONTEXTUAL EMBEDDINGS

(71) Applicant: INTERNATIONAL BUSINESS MACHINES CORPORATION, Armonk, NY (US)

(72) Inventors: Saurabh Pujar, White Plains, NY (US); Luca Buratti, White Plains, NY (US); Alessandro Morari, New York, NY (US); Jim Alain Laredo, Katonah, NY (US); Alfio Massimiliano Gliozzo, Brooklyn, NY (US); Gaetano Rossiello, Brooklyn, NY (US)

(21) Appl. No.: 16/917,962

(22) Filed: Jul. 1, 2020

(51) Int. Cl. G06F 21/57; G06F 21/56; G06F 21/54; G06K 9/62

(52) U.S. Cl. CPC G06F 21/577; G06F 21/563; G06K 9/6259; G06F 21/54; G06F 21/564

(57) ABSTRACT

A method, a computer system, and a computer program product for vulnerability analysis using contextual embeddings is provided. Embodiments of the present invention may include collecting labeled code snippets. Embodiments of the present invention may include preparing the labeled code snippets. Embodiments of the present invention may include tokenizing the labeled code snippets. Embodiments of the present invention may include fine-tuning a model. Embodiments of the present invention may include collecting unlabeled code snippets. Embodiments of the present invention may include predicting a vulnerability of the unlabeled code snippets using the model.

### STATEMENT REGARDING PRIOR DISCLOSURES BY THE INVENTOR OR A JOINT INVENTOR

The following disclosure is submitted under 35 U.S.C. § 102(b)(1)(A): DISCLOSURE: The document, entitled “Exploring Software Naturalness Through Neural Language Models, authored by Luca Buratti, Saurabh Pujar, Mihaela Bornea, Scott McCarley, Yunhui Zheng, Gaetano Rossiello, Alessandro Moran, Jim Laredo, Veronika Thost, Yufan Zhuang, and Giacomo Domeniconi was made publicly available on Jun. 22, 2020 on the publication arXiv (https://arxiv.org/pdf/2006.12641.pdf).

### BACKGROUND

The present invention relates generally to the field of computing, and more particularly to natural language processing (NLP). Computer system and computer software vulnerabilities are prevalent with an increasing demand for technology. Software vulnerabilities are discovered often, many vulnerabilities being discovered after a compromise of a computer system, network or software code.

### SUMMARY

Embodiments of the present invention disclose a method, a computer system, and a computer program product for vulnerability analysis using contextual embeddings. Embodiments of the present invention may include collecting labeled code snippets. Embodiments of the present invention may include preparing the labeled code snippets. Embodiments of the present invention may include tokenizing the labeled code snippets. Embodiments of the present invention may include fine-tuning a model. Embodiments of the present invention may include collecting unlabeled code snippets. Embodiments of the present invention may include predicting a vulnerability of the unlabeled code snippets using the model.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for the vulnerability analysis using a contextual embedding pre-training phase according to at least one embodiment;

FIG. 3 is an operational flowchart illustrating a process for the vulnerability analysis using a contextual embedding fine-tuning phase according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein, however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

As previously described, computer system and computer software vulnerabilities are prevalent with an increasing demand for technology. Software vulnerabilities are discovered often, many vulnerabilities being discovered after a compromise of a computer system, network or software code. Various techniques are used to detect computing vulnerabilities in source code, such as a detection of bugs or possible runtime exceptions. Industry standards tend to use a static analysis to detect program vulnerabilities. Static analyzers are a rule-based system and are prone to many false positive results. Additionally, the use of contextual embeddings with transformer architecture leads to architectural problems, such as the large context problem, that may follow.

Other methods of vulnerability detection may use a statistical analysis approach. Issues still prevail in the accuracy of vulnerability detection. Therefore, it may be advantageous to, among other things, create an accurate method to detect or predict program vulnerabilities.

The following described exemplary embodiments provide a system, a method and a program product for vulnerability analysis using contextual embeddings. As such, embodiments of the present invention have the capacity to improve the field of software analysis by accurately detecting computing system vulnerabilities. More specifically, vulnerabilities are detected by using language modeling and contextual embeddings to determine how words are used in reference to the word's context in the programming code or the source code.

Software vulnerability analysis using the presented vulnerability detection and prediction system, method and program product may also provide improvements in detecting vulnerabilities by incorporating window size limitations, code snippet segments, aggregation mechanisms (e.g., voting), the use of a neural network (NN) and the use of an abstract syntax tree (AST). Window size limitations may be overcome to allow examples with large contexts to be used with a transformer-based architecture. Window size limits may limit the size of the context or lose context that can be processed by a transformer or a model using a transformer architecture.

A transformer is a type of neural network architecture that may transform one sequence into another. The transformer may have the ability to process program data with context sizes that are smaller than the window size, however, the processing of data may be truncated, and a result may provide an incorrect output. For example, a typical transformer window size is 512 tokens and if a program or a function is less than 512 tokens, then the program or function may be processed normally. If the program has more than 512 tokens, then the program will be truncated and will result in an incorrect output since the full program was not processed.

Code snippets may be text data of a section of the programming code. Code snippets may be broken down into segments and different aggregation techniques may be used to improve classification. Aggregation techniques may include a simple OR mechanism that acts as a logic step similar to an OR gate or a logic gate. An OR mechanism example includes that if one of the segments gets classified as vulnerable, then the entire code snippet may also get classified as vulnerable. Aggregation may also include sophisticated neural network (NN) techniques, such as bidirectional long-short-term memory (BiLSTM) or a bidirectional long-short-term memory (BiLSTM) with an attention layer or an attention mechanism to get one classification for the entire code snippet. Neural networks (NN) may be used to analyze the output of a transformer layer. Abstract syntax trees (ASTs) may be used in conjunction with structural information.

According to an embodiment, natural language processing (NLP) may be used to perform language modeling to initialize vectors based off of words, which may also be considered tokens, provided to the model. Language modeling may determine probabilities of word sequences, such as word sequences in computer code or source code. Natural language processing may be used as part of the process of identifying vulnerabilities in source code. Source code may include computer programming language to be executed by a computing device, for example, source code project C and Java® (Java and all Java-based trademarks and logos are trademarks or registered trademarks of Oracle Corporation and/or its affiliates) source code project on Github® (Github and all Github-based trademarks and logos are trademarks or registered trademarks of Github, Inc. and/or its affiliates). Programming language can be viewed as a natural language that can be modeled using contextual embeddings.

Word embeddings used with natural language processing may create a distributed representation of words, such as words that represent the source code text. For example, word embedding techniques, such as Word2Vec, Sent2Vec or Doc2Vec, may be used to create word embeddings of computer programming code or source code. A limitation to word embeddings may include each word only having one embedding, such as the word “bank” will have the same embedding in the phrase “reserve bank” and “river bank.”

Alternatively, contextual embeddings allow embeddings of a word to depend on the context that is used. For example, the word “bank” can have different embeddings based on the context in which the word is used. Using contextual embeddings with programming code or source code as a dataset may allow multiple contexts to the sequence of words, subwords or characters provided.

Various types of machine learning (ML) models may be built to create predictive results for identifying code vulnerabilities using contextual embeddings. Training data, such as program code data and labeled code data, may be used to train, operate and continually update a model. Training data may include program code data that is used as source code from various domain applications, such as retail, social media content, business, technology, medical, academic, government, industrial, food chain, legal or automotive. Machine learning models may also include deep learning models, active learning models and artificial intelligence (AI) models.

Training and updating a model may include supervised, unsupervised and semi-supervised machine learning procedures. Supervised learning may use a labeled dataset or a labeled training set to build, train and update a model. Unsupervised learning may use all unlabeled data to train a model. Semi-supervised learning may use both labeled datasets and unlabeled datasets to train a model.

Natural language processing may be used to extract word sequences in source code to identify source code word contexts. Natural language processing may extract key features using contextual embedding techniques that map words and phrases in a given context to vectors of numbers using mathematical embeddings. Contextual embeddings may create an understanding of the occurrence of words or terms, in context and in relation to each other, in a document corpus. When word and phrase embeddings are used, the natural language processing accuracy may improve the semantic analysis. Pre-trained models and deep learning models that use natural language processing and word embeddings may provide more accurate predictive results.

Pre-trained language models may also be used to create predictive results for identifying code vulnerabilities using contextual embeddings. For example, the ability to accurately predict (i.e., reduce the high false positive results provided by static analyzers) vulnerabilities in source code or in source code snippets can assist software developers' with productivity levels and may assist the software code developers' in writing a more secure code.

A pre-trained language model may include a model that was previously trained and designed as a benchmark model for a particular dataset. A pre-trained model may also be called a natural language processing (NLP) model. The previously trained model for a specified NLP dataset may include feeding a model an unannotated dataset for training purposes. The unannotated or unstructured data may be classified or tagged for model training.

A pre-trained model may require a smaller dataset as the training is created for specific tasks. For example, data, such as computer programming code may be provided to a language model with a specified algorithm. The word representations from the language model output may include a generally embedded context of the words. The produced word embeddings from the initial training may not be context specific, therefore, the embeddings may be fine-tuned for a specific task and a specific dataset.

Fine tuning a model may include various types of updates or amendments to classifications, tags, labels or embeddings. Updates to a model may include a user feedback, such as a subject matter expert, to provide ground truth for improving the accuracy of further training a model. Fine tuning may also be accomplished using a transformer or a deep learning model. A transformer may transform one sequence into another, for example, receive embeddings as an input and provide probabilities as an output. Sequence-2-sequence (seq2seq) may transform, for example, a sequence of words in the source code to another sequence of words. A long-short-term-memory (LSTM) model may be used to analyze sequence dependent data.

Natural language processing may be utilized during the building, training and learning phases of a model. Analysis of both structured and unstructured data may be incorporated into the building, training and learning phases. Natural language processing may be represented mathematically and may be used to analyze initialized vectors and vulnerabilities in programming code. Structured and unstructured data may also be used as datasets to train contextual embeddings.

Structured data may include data that is highly organized, such as a spreadsheet, relational database or data that is stored in a fixed field. Structured data may also include labeled data (i.e., text file with labels), such as labeled code snippets. Unstructured data may include data that is not organized and has an unconventional internal structure, such as programming language, source code (e.g., a text file), a code snippet, a portable document format (PDF), a webpage, an email or a word processing document.

Historical data and current data may be used for the model building, training, learning and fine-tuning phases. The historical data and current data may include, for example, programming language, source code data and code snippet data. For example, source code data may be captured from an open source code repository or a private repository with proper accessibility permissions. Data may also be synthetically generated by programs that generate data.

The collection of the program code data, the source code data or the labeled code snippets data may be stored or retrieved on one or more databases. Structured and unstructured data may be mined from domain databases to collect the data for a vulnerability analysis using natural language processing and word embedding techniques. Source code may include data obtained from the various domain application repositories, such as telecommunication data, medical data, financial data, legal data, legislative data, business data, transportation data, agriculture data or industrial data. For example, a project in python language in a health care domain repository.

According to an embodiment, contextual embeddings may be applied to the collected and stored source code to detect vulnerabilities. Applying contextual embeddings may, for example, include identifying that a word may have more than one meaning and analyzing the words surrounding the single word to provide context to the term being defined. A term (e.g., a word) may refer to multiple potential meanings and importance in a context being utilized and the term may need to be disambiguated to the true meaning of the term in the context of the best use of the term, such as the context of computer programming code. Contextual embeddings may be represented as vectors that are analyzed to determine how a word is used in reference to the word's context. The contextual embeddings may be used, for example, on source code to fine tune the contextual embeddings using a transformer-based architecture for vulnerability analysis.

Additionally, contextual embeddings for a word may be captured semantically to bring the word into a correct or proper context. Semantic analysis may be used to infer the complexity of interactions, such as the meaning and intent of the language, such as the programming language or the source code for a computer. Semantic analysis may consider syntactic structures at various levels to infer meaning to a user's words, phrases or sentences.

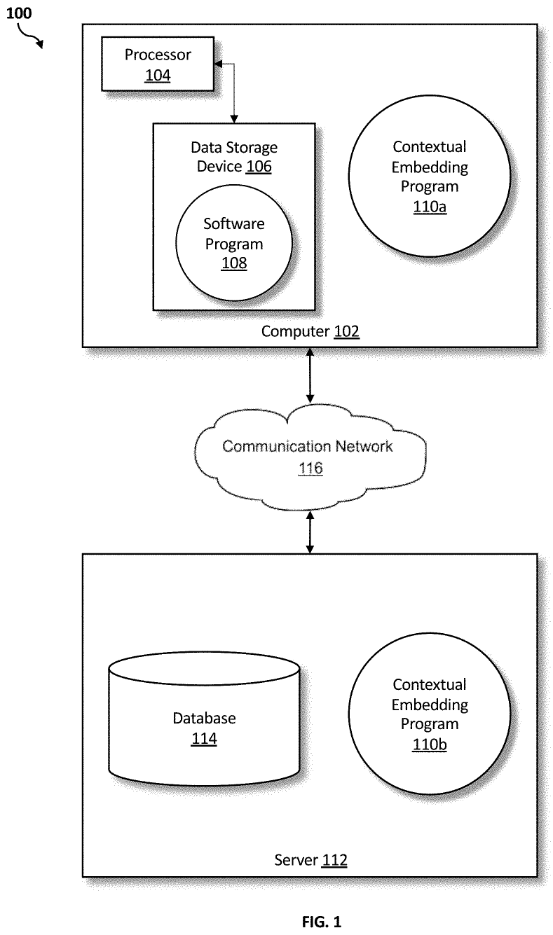

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a contextual embedding program 110a. The networked computer environment 100 may also include a server 112 that is enabled to run a contextual embedding program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

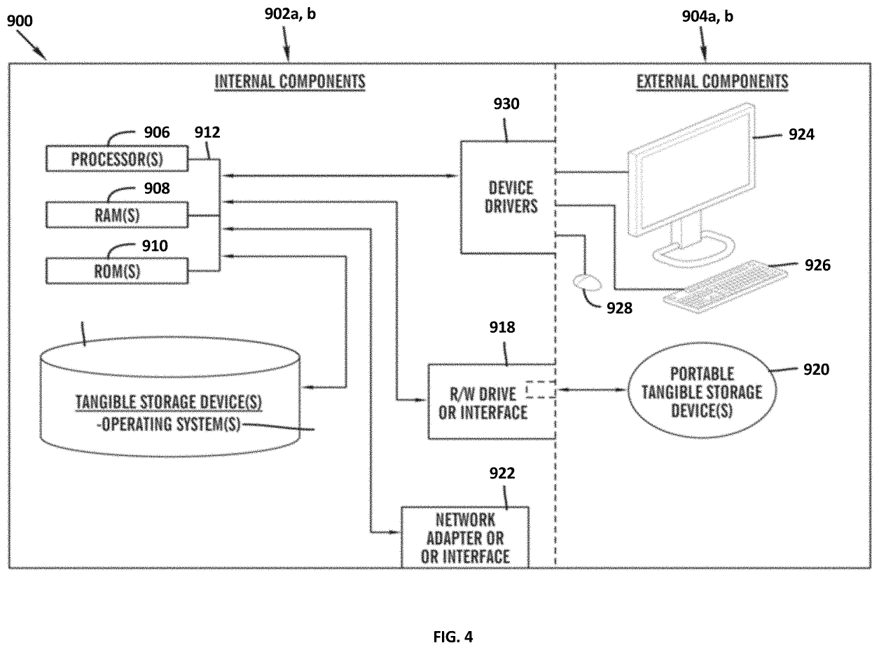

The client computer 102 may communicate with the server computer 112 via the communications network 116. The communications network 116 may include connections, such as wire, wireless communication links, or fiber optic cables. As will be discussed with reference to FIG. 4, server computer 112 may include internal components 902a and external components 904a, respectively, and client computer 102 may include internal components 902b and external components 904b, respectively. Server computer 112 may also operate in a cloud computing service model, such as Software as a Service (SaaS), Analytics as a Service (AaaS), Blockchain as a Service (BaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the contextual embedding program 110a, 110b may interact with a database 114 that may be embedded in various storage devices, such as, but not limited to a computer/mobile device 102, a networked server 112, or a cloud storage service.

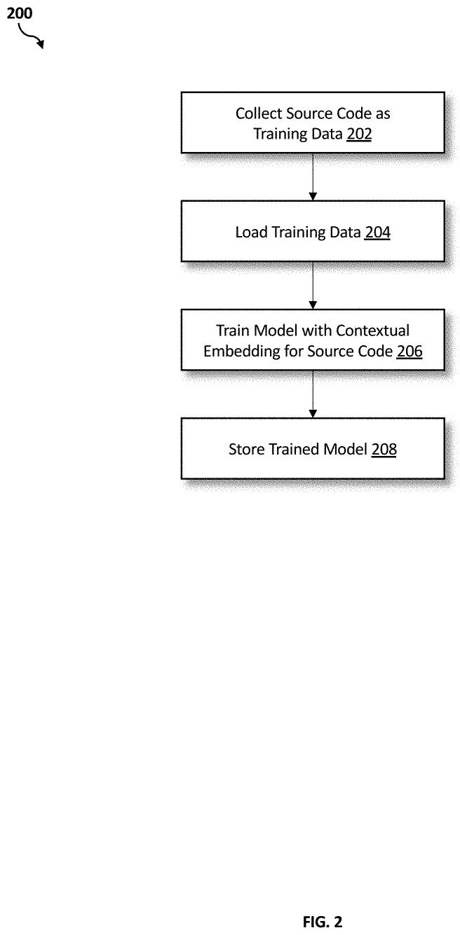

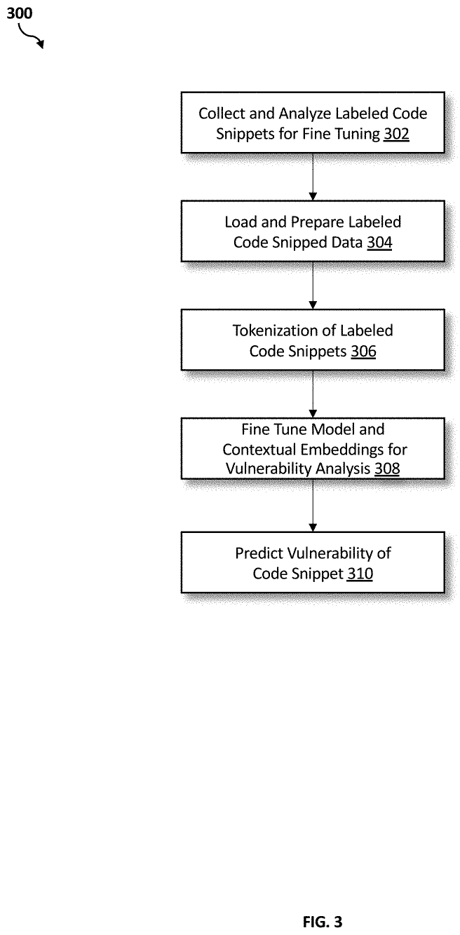

According to the present embodiment, a user using a client computer 102 or a server computer 112 may use the contextual embedding program 110a, 110b (respectively) to analyze, detect and predict vulnerabilities of a computing system using contextual embeddings. The contextual embedding method is explained in more detail below with respect to FIGS. 2 and 3.

Referring now to FIG. 2, an operational flowchart illustrating the exemplary vulnerability analysis using a contextual embedding pre-training phase process 200 used by the contextual embedding program 110a, 110b according to at least one embodiment is depicted.

At 202, source code is collected as training data. The training data may include data that is collected and used to train a model for a pre-training phase. The training data may, for example, include source code that is collected from an open source computer programming repository. The source code may be used as training data to create contextual embeddings using the words in the source code.

Source code may be collected from various repositories that store source code for multiple domains. Source code collected for training may be obtained, for example, from source code projects or an open source accessibility to source code. Source code and other types of computer programming code may be collected from domain specific applications with proper accessibility to the source code repositories.

At 204, training data is loaded. The training data from source files may be analyzed (i.e., the program reads the data) by a data loader and converted into a form that the model can identify and be trained from. Data loading may include reorganizing the training data to a form used for training if the data obtained from the repository is not already in the required form. For example, if the source files obtained from a repository and used for training data are in the required form, then no changes may need to be made for the data loading process and alternatively, if some of the data is not in the required form, then the data loader can reorganize or transform the source file data to information that the model can use or consume for training.

At 206, train a model with contextual embedding for the source code. The collected training data or the collected source code may be allocated for model training. The model training may include, for example, utilizing the training data as data to train a natural language model or a machine learning model. The training data may include the ability to use a smaller dataset to train the model for a specific task. The natural language model may be trained, for example, as a pre-trained model using a smaller dataset, such as source code, to perform a specific task, such as creating embeddings for the source code. Other pre-trained models may also be used with the collected training data, such as bidirectional encoders to encode the loaded training data.

The source code may be represented as an abstract syntax tree. The abstract syntax tree may include a tree representation of the abstract syntax structure of the source code written in a programming language. The model may be trained using natural language processing to identify contextual embeddings in the source code. The identified contextual embeddings may capture long range dependencies. In natural language processing, words may be related to or dependent on each of the other words and long range dependencies may include words related to or dependent on other words that are not next to each other or that are separated by many other words in a sentence. The dependency of one word that is dependent upon another word in the sentence that has other words separating the dependent words may be captured by contextual embeddings. Long range dependencies may be captured for the words located in programming code or source code. The identified contextual embeddings may also capture the structure of the captured source code text. Contextual embeddings may be associated as a vector. Each vector may have a token associated with the vector. The vector may change according to the surrounding context of the token.

Contextual embeddings may also be learned by the model using, for example, unsupervised training on the received dataset. The contextual embeddings may be analyzed using transformers and natural language processing. The trained model may include the source code with the identified contextual embeddings to be labeled datasets.

At 208, the trained model is stored. The trained model may be stored in a repository or a database. The database that stores the trained model may be accessed during the fine-tuning phase for future vulnerability analyses.

Referring now to FIG. 3, an operational flowchart illustrating the exemplary vulnerability analysis using a contextual embedding fine-tuning phase process 300 used by the contextual embedding program 110a, 110b according to at least one embodiment is depicted. The contextual embedding fine-tuning phase process 300 may provide a system, method and program product to use the contextual embeddings on source code from the contextual embedding pre-training phase process 200 to fine tune the contextual embeddings with transformer architecture for a vulnerability analysis.

At 302, labeled code snippets are collected and analyzed for fine tuning. Labeled code snippets may include snippets of data or sections of programming code that are open sourced and available to the public. A code snippet may be labeled by, for example, companies, universities or research teams that either run a program over the code snippets for labeling or that manually label the code snippets and post them or make them accessible in a public repository. Labeled code snippets may have undergone extensive preparation to be labeled by companies and the resulting labeled code snippets, for example, that were created programmatically, may be called a synthetic dataset.

Labeled code snippets may be considered a labeled dataset obtained from a trained model or from being labeled using natural language processing. A labeled code snippet may include a section of programming code that has contextual embeddings. The labeled dataset may include training data or a validation split. A validation split may include data that is split into two sets, such as training data and testing data. Labels may be identified as safe code snippets or vulnerable code snippets as, for example, by representing a safe code snippet as a zero (0) and a vulnerable code snippet as a one (1).

Fine tuning a model may include running one or more datasets through a model that has been built to further the training. For example, the previous dataset may be truncated, and a next dataset may be provided that is more related to fine tuning the model for computer programming language. Fine tuning may include the process of learning which code snippets are mapped to the correct label. The label may assist later in the process for identifying a vulnerability in the code snippet.

At 304, the labeled code snippets are loaded and prepared. The labeled code snippets are downloaded or received from step 302 and then the data is pre-processed and loaded into, for example, the data loader. The labeled code snippets may, for example, be a piece of code in a main program that is loaded into a data loader. The labeled and collected code snippets may be analyzed and prepared by tokenizing the labeled dataset with the same or maybe even with different tokenization that was applied in the pre-training at step 204. Preparation may include utilizing, for example, abstract syntax trees (ASTs) to include a tree representation of the abstract syntax structure of the source code written in a programming language. Preparation may also include breaking down long functions into multiple segments.

At 306, the labeled code snippets are tokenized. Tokens may be used to break down the text, such as a code snippet, into multiple tokens. Labeled code snippets may be assigned to tokens. Tokens can be utilized in many ways and one example may include the words “this is a sentence” to be broken down into 4 tokens. One token for each word, for example, token1=this, token2=is, token3=a and token4=sentence. Each contextual embedding may be mapped to a token and each contextual embedding may represent tokens, for example, of code snippets. Each token in the source code vocabulary may include a feature or a word. For example, single character, single character plus keywords or byte pair encoding plus keywords. A single character in a term or a word may be token1. Single character plus keywords may be token1 plus keywords.

The code snippets may be processed using a proxy OR aggregation system or an OR mechanism that may overcome the max sequence length problem. For example, an abstract syntax tree (AST) may be used for an OR mechanism. A max sequence length problem may include, for example, long code snippets or programs with a number of tokens too big for the architecture used to create contextual embeddings. OR aggregation may happen at one or more stages during the vulnerability analysis using a contextual embedding fine-tuning phase process 300, such as during the preparation phase. However, modifications may be made or may be required to vote at different phases. Aggregation may also happen during a model prediction phase or after a prediction is made.

At 308, the model and the contextual embeddings are fine tuned for a vulnerability analysis. Fine tuning the model and the contextual embeddings for vulnerability analysis may use a neural network to combine the outputs provided by the transformers. After the data is loaded and the data is tokenized, each token may be mapped to a corresponding contextual embedding, which is then fed into the transformer.

For example, a hierarchal transformer may be used to fine tune the model. A hierarchal transformer may limit the attention capacity of the transformer to a fixed size. In order to keep into account a code snippet with more tokens than the attention capacity, it may be possible to aggregate representations computed with transformer architecture for different sub pieces of a code snippet, for example, using long-short-term memory (LSTM), other transformers or an OR system.

Fine tuning a model may include various types of updates or amendments to classifications, tags, labels or embeddings. Updates to a model may include a user feedback, such as a subject matter expert, to provide ground truth for improving the accuracy of further training a model. Fine tuning may also be accomplished using a transformer or a deep learning model. A transformer may transform one sequence into another, for example, receive embeddings as an input and provide probabilities as an output. Sequence-2-sequence (seq2seq) may transform, for example, a sequence of words in the source code to another sequence of words. A long-short-term-memory (LSTM) model may be used to analyze sequence dependent data.

At 310, the vulnerability of the code snippets is predicted. The model may predict or detect whether a code snippet is vulnerable. The vulnerability analysis may be made using an unlabeled set of code snippets that may be fed into the fine-tuned model. Vulnerability prediction of the code snippet may be made using the contextual embeddings. The vulnerability analysis may include a task of predicting if a piece of code can be exploited in a way that the system built on it can crash or give unwanted behaviors. Exploited code may be or may become malicious to a computing system. A computing vulnerability may become a security concern, for example, a computer vulnerability creates a weaker system that a hacker may infiltrate and obtain private content or may insert code that is malicious and can reduce the security of the system.

The model may then be able to take a code snippet input and predict the vulnerability or the safeness of the code snippet as an output. The output may be a label for a code snippet. The output may include, for example, any label that indicates whether or not the code snippet has a vulnerability or a type of vulnerability. The output may be helpful for a user that would like to detect vulnerabilities in source code, such as a software developer or an engineer. The model allows software developers to scan code snippets of software that were written to detect vulnerabilities in the software code so that the problem can be corrected.

It may be appreciated that FIGS. 2 and 3 provide only an illustration of one embodiment and do not imply any limitations with regard to how different embodiments may be implemented. Many modifications to the depicted embodiment(s) may be made based on design and implementation requirements.

FIG. 4 is a block diagram 900 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 4. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the contextual embedding program 110a in client computer 102, and the contextual embedding program 110b in network server 112, may be stored on one or more computer-readable tangible storage devices 916 for execution by one or more processors 906 via one or more RAMs 908 (which typically include cache memory). In the embodiment illustrated in FIG. 4, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the contextual embedding program 110a, 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the contextual embedding program 110a in client computer 102 and the contextual embedding program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the contextual embedding program 110a in client computer 102 and the contextual embedding program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure or on a hybrid cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

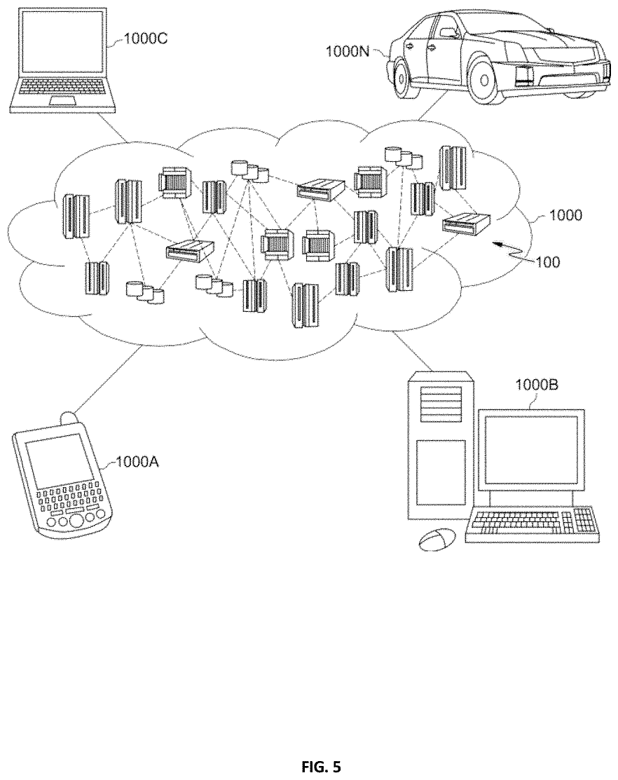

Referring now to FIG. 5, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 5 are intended to be illustrative only and that computing nodes 100 and cloud computing environment 1000 can communicate with any type of computerized device over any type of network and/or network addressable connection (e.g., using a web browser).

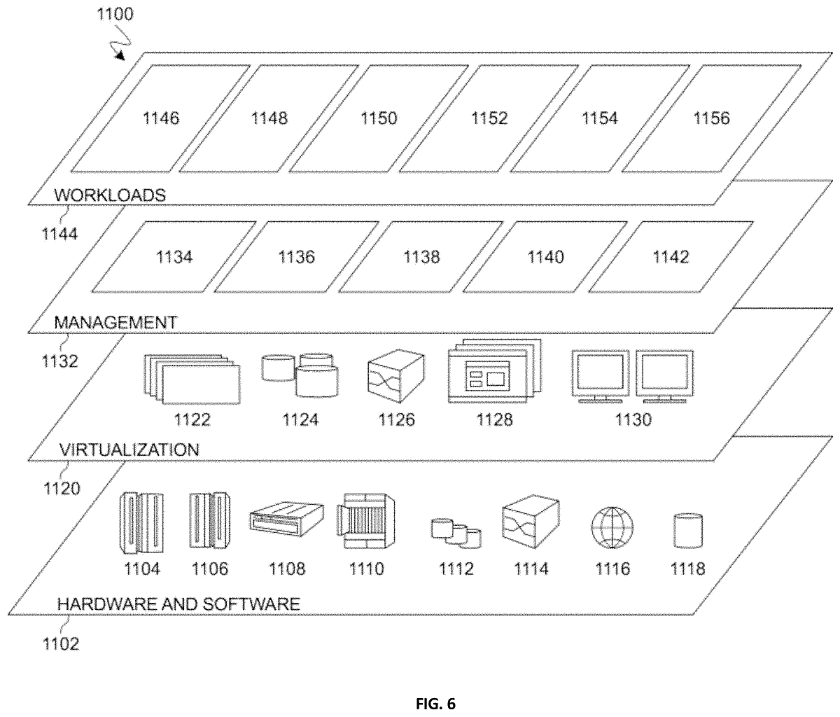

Referring now to FIG. 6, a set of functional abstraction layers 1100 provided by cloud computing environment 1000 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and vulnerability analysis using contextual embeddings 1156. A contextual embedding program 110a, 110b provides a way to determine and predict computing system vulnerabilities using contextual embeddings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language, python programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for a vulnerability analysis using contextual embeddings, wherein contextual embeddings are used to determine how words are used in reference to the words' context in a programming code or a source code, the method comprising:
collecting labeled code snippets;
preparing the labeled code snippets;
tokenizing the labeled code snippets;
determining a context for the labeled code snippets based on the contextual embeddings;
fine-tuning a model;
collecting unlabeled code snippets; and
predicting a vulnerability of the unlabeled code snippets using the model.

2. The method of claim 1, further comprising:
collecting source code as training data;
loading the training data;
training the model using the contextual embeddings for the source code; and
storing the model.

3. The method of claim 1, wherein the labeled code snippets include sections of source code that are labeled.

4. The method of claim 1, wherein the preparing the labeled code snippets includes creating an abstract syntax tree (AST) representation of the abstract syntax structure of source code.

5. The method of claim 1, wherein the tokenizing the labeled code snippets includes using contextual embeddings to represent tokens of the labeled code snippets.

6. The method of claim 1, wherein the fine-tuning the model includes mapping tokens to corresponding contextual embeddings.

7. The method of claim 1, wherein the predicting the vulnerability includes determining if the unlabeled code snippets are vulnerable or can be exploited to create unwanted behaviors in a computing system.

8. A computer system for vulnerability analysis using contextual embeddings, wherein contextual embeddings are used to determine how words are used in reference to the words' context in a programming code or a source code, comprising:
a computer processor coupled to a computer-readable memory unit, the computer-readable memory unit comprising instructions that when executed by the computer processor implements a method comprising:
collecting labeled code snippets;
preparing the labeled code snippets;
tokenizing the labeled code snippets;
determining a context for the labeled code snippets based on the contextual embeddings;
fine-tuning a model;
collecting unlabeled code snippets; and
predicting a vulnerability of the unlabeled code snippets using the model.

9. The computer system of claim 8, further comprising:
collecting source code as training data;
loading the training data;
training the model using the contextual embeddings for the source code; and
storing the model.

10. The computer system of claim 8, wherein the labeled code snippets include sections of source code that are labeled.

11. The computer system of claim 8, wherein the preparing the labeled code snippets includes creating an abstract syntax tree (AST) representation of the abstract syntax structure of source code.

12. The computer system of claim 8, wherein the tokenizing the labeled code snippets includes using contextual embeddings to represent tokens of the labeled code snippets.

13. The computer system of claim 8, wherein the fine-tuning the model includes mapping tokens to corresponding contextual embeddings.

14. The computer system of claim 8, wherein the predicting the vulnerability includes determining if the unlabeled code snippets are vulnerable or can be exploited to create unwanted behaviors in a computing system.

15. A computer program product for vulnerability analysis using contextual embeddings, wherein contextual embeddings are used to determine how words are used in reference to the words' context in a programming code or a source code, comprising a computer readable storage medium having program instructions embodied therewith, the program instructions executable by an electronic device to cause the electronic device to perform actions of:
collecting labeled code snippets;
preparing the labeled code snippets;
tokenizing the labeled code snippets;
determining a context for the labeled code snippets based on the contextual embeddings;
fine-tuning a model;
collecting unlabeled code snippets; and
predicting a vulnerability of the unlabeled code snippets using the model.

16. The computer program product of claim 15, further comprising:
collecting source code as training data;
loading the training data;
training the model using the contextual embeddings for the source code; and
storing the model.

17. The computer program product of claim 15, wherein the labeled code snippets include sections of source code that are labeled.

18. The computer program product of claim 15, wherein the preparing the labeled code snippets includes creating an abstract syntax tree (AST) representation of the abstract syntax structure of source code.

19. The computer program product of claim 15, wherein the tokenizing the labeled code snippets includes using contextual embeddings to represent tokens of the labeled code snippets.

20. The computer program product of claim 15, wherein the fine-tuning the model includes mapping tokens to corresponding contextual embeddings.
